(19) United States
(12) Patent Application Publication
(10) Pub. No.: US 2004/0031820 A1
(43) Pub. Date: Feb. 19, 2004

(54) Reclosable container

(76) Inventor: Frances R. Maggi, Chicago, IL (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/217,717

(22) Filed: Aug. 13, 2002

(51) Int. Cl. G01F 11/28

(52) U.S. Cl. 222/457

(57) ABSTRACT

The present invention is directed to a container for storing and dispensing articles, such as snack food. In one embodiment the container comprises a tray that can be easily opened and closed. When open, articles fall by gravity into the tray, permitting easy access to the articles. In a preferred embodiment, when the tray is closed, the container is airtight.

### BACKGROUND OF THE INVENTION

1. Field of the Invention

The present invention is directed to a container for storing and dispensing articles, such as snack foods, candies, cake decorating products, cookies, office supplies, hardware products, craft items, and the like.

2. Description of the Related Art

Prior art containers for storing and dispensing articles, especially small articles such as snacks, generally consist of bags, boxes, tubes, or bowls.

Bags can tear easily when opened and, when used to store foods, are often difficult to close in a way that helps to maintain the freshness of the product. Bags are sometimes folded down and clipped closed to maintain product freshness. The bag, however, does not come equipped with the clip. Bags also sometimes are equipped with a zipper to re-close the bag. The consumer must be careful when opening the bag not to damage the zipper. Zippers are also sometimes difficult to close tightly. In addition, bags will easily tip over and spill the product. Boxes also frequently tear when opened and can be difficult to re-close in a manner that helps to maintain product freshness.

Tubes and bowls offer some advantages over bags and boxes. For example, they can be easily resealed. However, bags, boxes, and tubes, for practical purposes, limit access to one person at a time. To offer easy access to multiple people at a time, bags, boxes and tubes require the use of a separate serving dish. Bowls are not always the most practical way to distribute articles, such as snack products. For example, they do not easily fit into display racks for sale at grocery stores. Bowls can also leave the stored product fully exposed to the environment.

Therefore it can be appreciated that there is a significant need for a container that is closable and that, when open, permits access to articles contained therein.

### BRIEF SUMMARY OF THE INVENTION

The present invention is directed to a container for storing and dispensing articles, such as snack foods, candies, cake decorating products, office supplies, hardware products, craft items, etc. In one embodiment the container is self-standing and has a tray that can be easily opened and closed. When open, articles in the container fall by gravity into the tray, permitting easy access to the product. When the tray is closed, the container may be semi-airtight, airtight or watertight, or some combination thereof, helping to preserve any articles contained therein.

### BRIEF DESCRIPTION OF THE SEVERAL VIEWS OF THE DRAWING(S)

FIG. 1 is a view of an embodiment of the container when the tray is open.

FIG. 2 is a view of an embodiment of the container when the tray is closed.

FIG. 3 is a view of an embodiment of the container when the tray and a top are closed.

FIG. 4 is a view of an embodiment of the container when the tray and the top are open.

FIG. 5 is a view of an embodiment of the container illustrating food in the tray.

FIG. 6 is a view of an embodiment of the container illustrating a pouring spout.

FIG. 7 is a view of an embodiment of a tray illustrating a slot for forming a seal with an opening in the container.

FIG. 8 is a view of an embodiment of the container.

### DETAILED DESCRIPTION OF THE INVENTION

The present invention is directed to a container for storing and dispensing articles, such as snack foods, cereal, candies, cake decorating products, cookies, office supplies, hardware products, craft items, etc., and to a method for distributing articles.

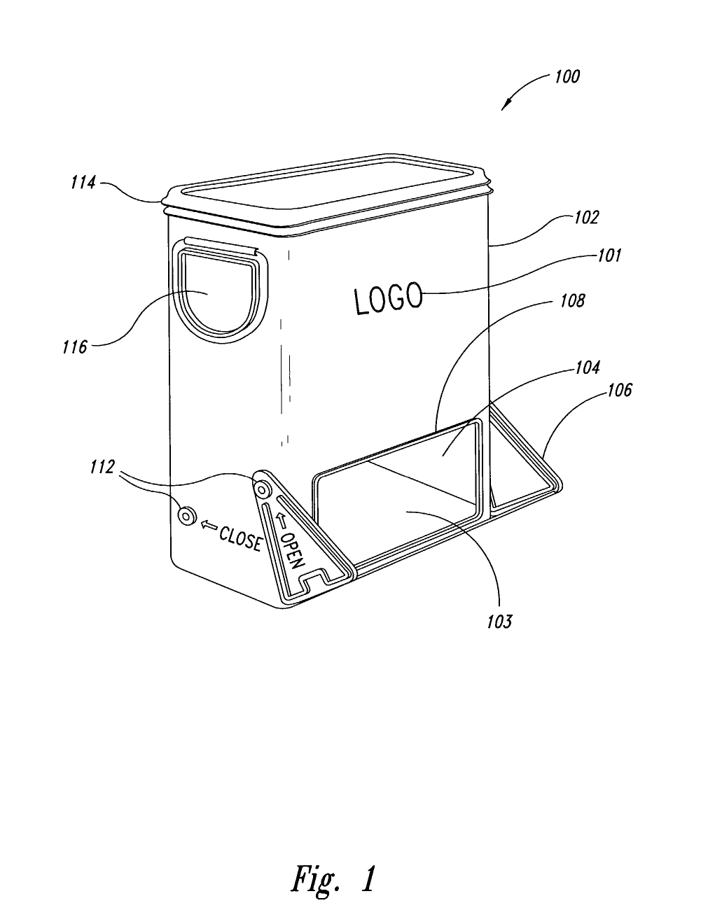

Various embodiments of the container are illustrated in FIGS. 1 through 8. As illustrated in FIG. 1, the container 100 has a body 102. The container 100 may be self-standing on a flat surface (not shown). The body 102 has a cavity 103 with an opening 104. The container also has a tray 106. The container 100 may be comprised of plastic components or may be made of other materials, such as cardboard, paper, metal, or some combination thereof. The container 100 may be made in various sizes to accommodate item and quantity preferences.

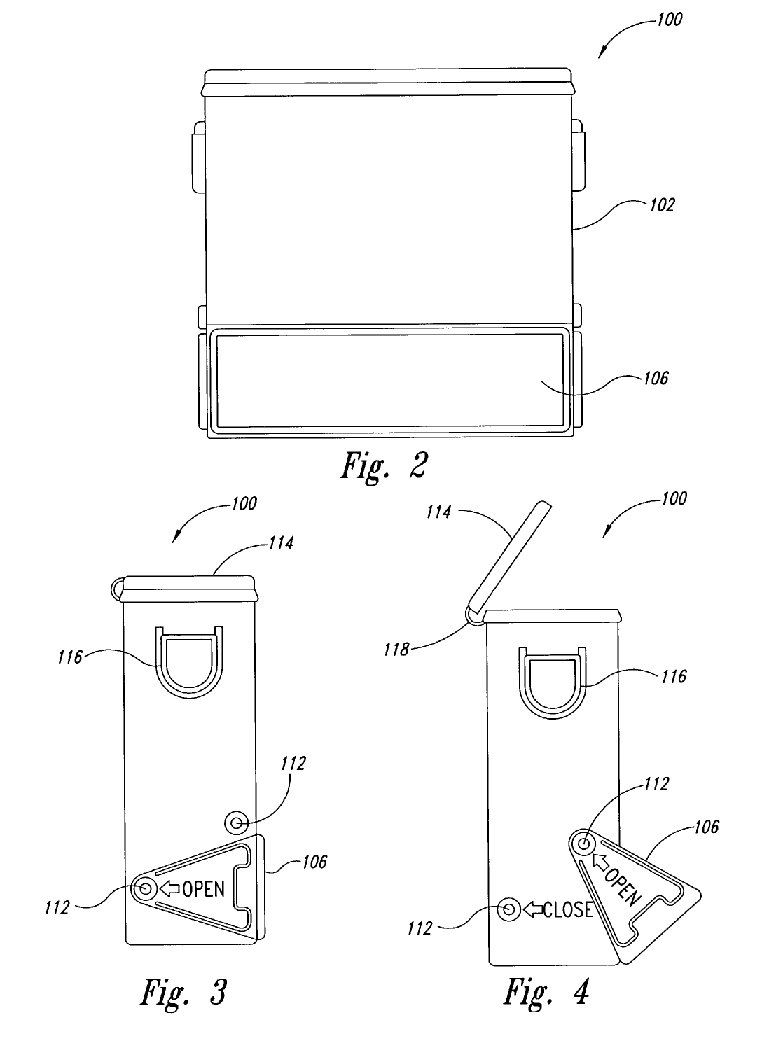

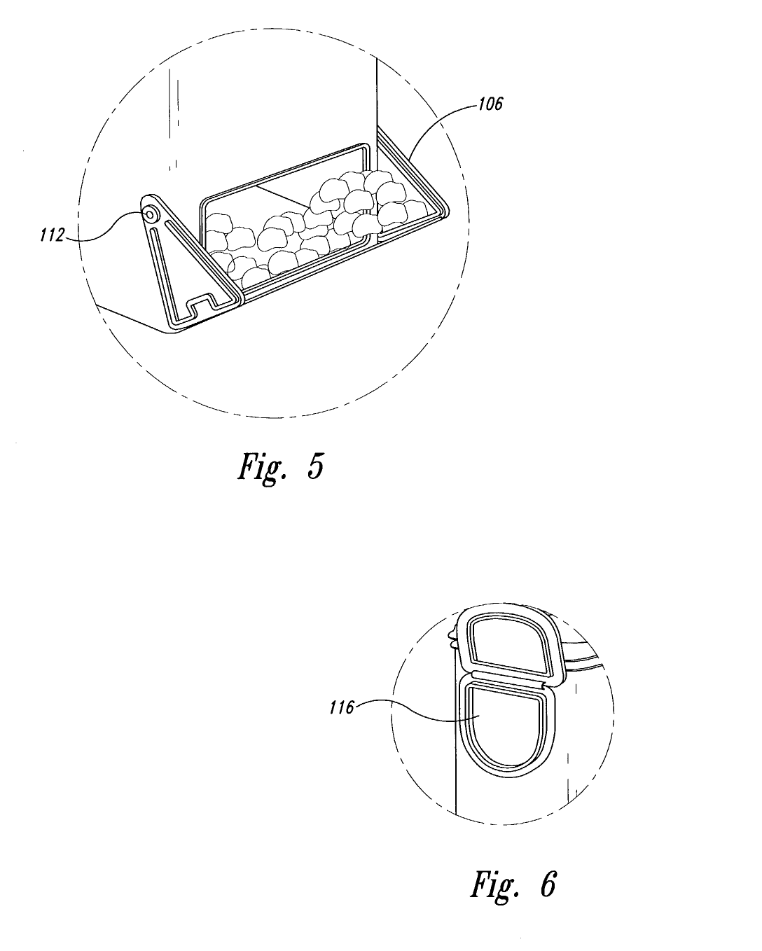

When the tray 106 is open (see FIGS. 1, 4 and 5), articles in the cavity 103 (see FIG. 5) fall by gravity from the cavity 103 through the opening 104 into the tray 106. In this position, the tray 106 supports some of the articles, permitting easy access to the articles. When the tray 106 is closed (see FIGS. 2 and 3), the opening 104 is obstructed by the tray 106.

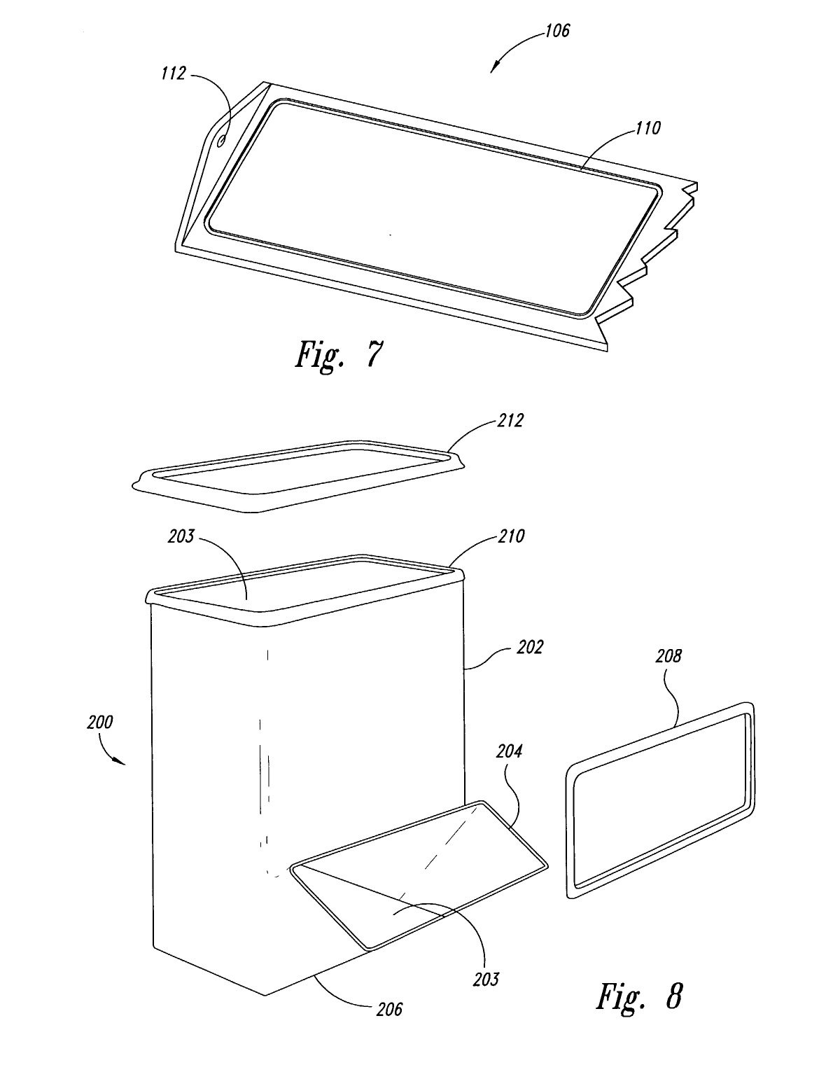

In a preferred embodiment, when closed the tray 106 forms a semi-airtight seal or airtight seal with the opening 104. The opening 104 may have a ridge 108 to facilitate the forming of a semi-airtight or airtight seal between the tray 106 and the opening 104 when the tray 106 is the closed position. The tray 106 may have a corresponding slot 110 (see FIG. 7) for forming the semi-airtight seal with the opening 104. Alternatively, other sealing methods may be employed. For example, the tray 106 may have a ridge (not shown), the opening 104 may have a corresponding slot (not shown), or a zipper mechanism may be employed (not shown). The tray 106 also may form a watertight seal with the opening 104.

In one embodiment, the tray 106 can be locked into open and closed positions. The tray 106 can be locked into a position using snaps 112. Alternatively, the tray 106 can be locked into the closed position by a seal formed between the tray 106 and the opening 104, with the tray 106 resting in the open position. Alternatively, other closing mechanisms can be employed, such as a piece of fabric with small hooks that engage a corresponding piece of fabric with small loops (not shown), or tabs and corresponding slots (not shown).

The container 100 may also have additional openings. For example, the container 100 may have a top 114 that can be opened and closed in a conventional manner. An example top 114 is illustrated in the open position in FIG. 4. The top 114 also may be hinged to the container 100 by a hinge 118, as shown in FIG. 4. The container 100 may also have a pour spout 116 that can be opened and closed, as shown in FIGS. 1, 3, 4 and 6.

The container 100 may be labeled for commercial sale, as illustrated by label 101 shown in FIG. 1.

Another embodiment of the container is illustrated in FIG. 8. The container 200 has a body 202. The container 200 may be self-standing on a flat surface (not shown). The body 202 has a cavity 203. The body also has a tray 206 with an opening 204. The container 200 has a cover 208 that can be used to close the opening 204 in the tray 206. The cover 208 may be completely removable, as shown in FIG. 8, or may be attached to the container 200. For example, the cover 208 may be attached to the container 200 with a hinge (see FIG. 4). As illustrated in FIG. 8, the container also has a second opening 210 and a second cover 212.

Small articles in the cavity 203 fall by gravity into the tray 206. The tray 206 supports some of the small articles, permitting easy access to the articles through the opening 204 when the cover 208 is open. When the cover 208 is closed, the opening 204 is obstructed by the cover 208.

The container, as illustrated for example in FIGS. 1 through 8, can be used in a method to facilitate the distribution and dispensing of a plurality of articles. The articles can be inserted into a container, such as the container 100 through an opening, such as opening 104 as illustrated in FIG. 1. The opening may then be sealed and the container shipped to another location. One of skill in the art will recognize that the articles can be inserted into the container 100 through an opening other than opening 104. The container may be provided with a serving tray, such as tray 106 in FIG. 1, that is moveably coupled to the container to manually move between a dispensing position in which the tray is oriented to receive and support at least some of the articles to facilitate removal, and a closed position in which the tray prevents the articles from escaping the container.

From the foregoing it will be appreciated that, although specific embodiments of the invention have been described herein for purposes of illustration, various modifications may be made without deviating from the spirit and scope of the invention. Accordingly, the invention is not limited except as by the appended claims and equivalents thereof.

1. A container for storing and dispensing a plurality of articles comprising:
a body having a cavity configured to store the plurality of articles;
an opening in the body sized to allow the articles to exit the cavity; and
a tray movably coupled to the body to manually move between a dispensing position in which the tray is oriented to receive at least some of the articles from the cavity and to support at least some of the articles to facilitate removal, and a closed position in which the tray obstructs the opening to prevent the articles from escaping from the body.

2. The container of claim 1 further comprising a closeable top.

3. The container of claim 2 further comprising a hinge to hold the closeable top on the container.

4. The container of claim 1 further comprising a closable pour spout to facilitate pouring articles from the container.

5. The container of claim 1 further comprising a plurality of snaps to hold the tray in the closed position.

6. The container of claim 1 further comprising a means to hold the tray in a closed position.

7. The container of claim 1 wherein the tray forms a semi-airtight seal with the body when tray is in the closed position.

8. The container of claim 1 wherein the tray is attached to the body directly.

9. The container of claim 1 wherein the container is self-standing.

10. The container of claim 1 wherein the articles are snack foods.

11. The container of claim 1 wherein the tray is pivotally attached to the body.

12. The container of claim 1 wherein the tray forms an airtight seal with the body when tray is in the closed position.

13. The container of claim 1 wherein the tray forms a watertight seal with the body when tray is in the closed position.

14. The container of claim 1 wherein the articles are small articles.

15. A method for facilitating distribution and dispensing of a plurality of articles comprising:
inserting the articles into a cavity in a container through an opening;
sealing the opening;
shipping the container to another location;
providing a serving tray on the container that is movably coupled to the container to manually move between a dispensing position in which the tray is oriented to receive at least some of the articles from the cavity and to support at least some of the articles to facilitate removal of the articles, and a closed position in which the tray prevents the articles from escaping from the container through the serving tray.

16. The method of claim 15 wherein the tray is attached to the container directly.

17. A container for storing and dispensing a plurality of articles, the container comprising:
a body having a cavity configured to receive the plurality of articles;
a tray sized and positioned to allow the articles to enter the tray from the cavity;
an opening in the tray sized to allow access to the articles; and
a cover for closing the opening in the tray.

18. The container of claim 17, further comprising an opening in the body and a cover for closing the opening in the body.

19. A method for facilitating distribution and dispensing of a plurality of articles, such as food, comprising:
inserting the articles into a cavity in a container through an opening;
sealing the opening;
shipping the container to another location; and
providing a serving tray on the container that is oriented to receive at least some of the articles from the cavity and to support at least some of the articles to facilitate removal, and that can be closed to prevent the articles from escaping from the container through the serving tray.
